(19) United States
(12) Patent Application Publication
(10) Pub. No.: US 2025/0279603 A1
(43) Pub. Date: Sep. 4, 2025

(54) Connector Combined Body

(71) Applicant: TE Connectivity Japan G. K., Kawasaki-shi (JP)

(72) Inventors: Yusuke Okada, Kawasaki-shi (JP); Eiichiro Takemasa, Kawasaki-shi (JP); Hirokazu Kato, Kawasaki-shi (JP)

(73) Assignee: TE Connectivity Japan G. K., Kawasaki-shi (JP)

(21) Appl. No.: 19/063,589

(22) Filed: Feb. 26, 2025

(30) Foreign Application Priority Data
Feb. 29, 2024 (JP) 2024-030320

(51) Int. Cl. H01R 12/75; H01R 4/2429

(52) U.S. Cl. CPC H01R 12/75; H01R 4/2429

(57) ABSTRACT

A connector combined body includes a cable side connector and a board side connector electrically connected and mated with the cable side connector. The cable side connector includes a main body part, a movable part connected to the main body part, and a first compound contact disposed in the main body part. The movable part is movable in one direction into the main body part and has a retaining portion in which a cable is inserted and retained. The cable includes a plurality of conductors, a plurality of insulators each separately surrounding one of the conductors, and a sheath surrounding the insulators. A first end side of the first compound contact is an insulation displacement contact. A movement of the movable part in the one direction pushes the insulation displacement contact into contact with the conductors of the cable.

### CROSS-REFERENCE TO RELATED APPLICATIONS

This application claims the benefit of the filing date under 35 U.S.C. § 119(a)-(d) of Japanese Patent Application No. JP2024-030320, filed on Feb. 29, 2024.

### FIELD OF THE INVENTION

The present disclosure relates to a connector and, more particularly, to a connector combined body.

### BACKGROUND OF THE INVENTION

Conventionally, a crossover wiring method has been employed to make an electrical connection between LED lighting units placed at predetermined intervals. In this method, each LED lighting unit is configured such that a power source or electric input side cable and a power source or electric output side cable, a terminal block, a power source module, and each LED are electrically connected to one another in this order. LED lighting units that are adjacent to each other are connected to each other by a cable. This interconnecting cable can function as an output side cable in one of the LED lighting units and functions as an input side cable in the other of the LED lighting units. Each of the aforementioned input side and output side cables may include a plurality of (e.g. two or three) conductors, insulators separately surrounding each of the plurality of conductors, and a sheath surrounding en bloc the plurality of conductors equipped with the insulators.

However, prior to making the electrical connection between the cable and the terminal block, a worker needs to perform the task of stripping off part of the sheath of each cable and part of each insulator. For example, a worker can strip off parts of the sheath and each insulator in each cable, expose each conductor inside, insert each conductor into the terminal block, and make an electrical connection between the cable and the terminal block. The task of stripping off part of the sheath of each cable and part of each insulator and exposing part of each conductor inside may decrease working efficiency.

### SUMMARY OF THE INVENTION

A connector combined body includes a cable side connector and a board side connector electrically connected and mated with the cable side connector. The cable side connector includes a main body part, a movable part connected to the main body part, and a first compound contact disposed in the main body part. The movable part is movable in one direction into the main body part and has a retaining portion in which a cable is inserted and retained. The cable includes a plurality of conductors, a plurality of insulators each separately surrounding one of the conductors, and a sheath surrounding the insulators. A first end side of the first compound contact is an insulation displacement contact. A movement of the movable part in the one direction pushes the insulation displacement contact into contact with the conductors of the cable.

### BRIEF DESCRIPTION OF DRAWINGS

The invention will now be described by way of example with reference to the accompanying figures, of which:

FIG. 1 is an isometric view of a connector combined body according to an exemplary embodiment;

FIG. 2A is an isometric view of a second cable side connector (output side) of the connector combined body of FIG. 1;

FIG. 2B is an isometric view of a first cable side connector (input side) of the connector combined body of FIG. 1;

FIG. 2C is a top view of the first cable side connector of FIG. 2B or the second cable side connector of FIG. 2A;

FIG. 2D is a cross-sectional view of the first cable side connector of FIG. 2B or the second cable side connector of FIG. 2A taken along line A-A of FIG. 2C;

FIG. 2E is a cross-sectional view of the first cable side connector of FIG. 2B or the second cable side connector of FIG. 2A taken along line B-B of FIG. 2C;

FIG. 2F is a cross-sectional view of the first cable side connector of FIG. 2B or the second cable side connector of FIG. 2A taken along line C-C of FIG. 2D;

FIG. 3A is an isometric front view of a board side connector of the connector combined body of FIG. 1;

FIG. 3B is an isometric rear view of the board side connector of FIG. 3A;

FIG. 3C is a front view of the board side connector of FIG. 3A;

FIG. 3D is a cross-sectional view of the board side connector of FIG. 3A taken along line D-D of FIG. 3C;

FIG. 3E is a cross-sectional view of the board side connector of FIG. 3A taken along line E-E of FIG. 3C;

FIG. 4A is an isometric view of a prior-to-use state of the second cable side connector of FIG. 2A;

FIG. 4B is an isometric view of a first usage state of the second cable side connector of FIG. 2A;

FIG. 4C is an isometric view of a second usage state of the second cable side connector of FIG. 2A;

FIG. 5A is an isometric view of a first usage state of the connector combined body of FIG. 1;

FIG. 5B is an isometric view of a second usage state of the connector combined body of FIG. 1; and

FIG. 5C is an isometric view of a third usage state of the connector combined body of FIG. 1.

### DETAILED DESCRIPTION

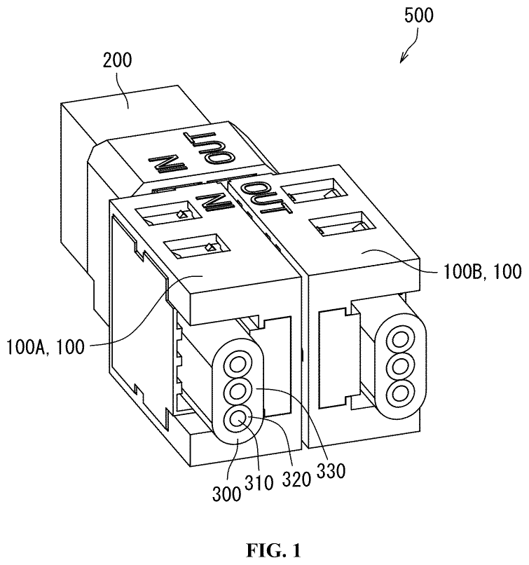

A configuration of a connector combined body 500 of the present disclosure is described below with reference to FIGS. 1-5C.

As shown in FIG. 1, the connector combined body 500 comprises a cable side connector 100 and a board side connector 200 that is electrically connectably mated with the cable side connector 100. That is, the connector combined body 500 is a structural body constituted by a combination of the cable side connector 100 and the board side connector 200.

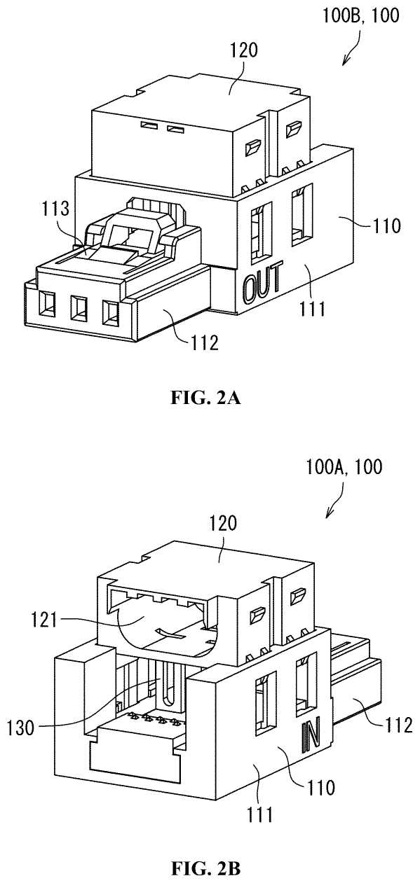

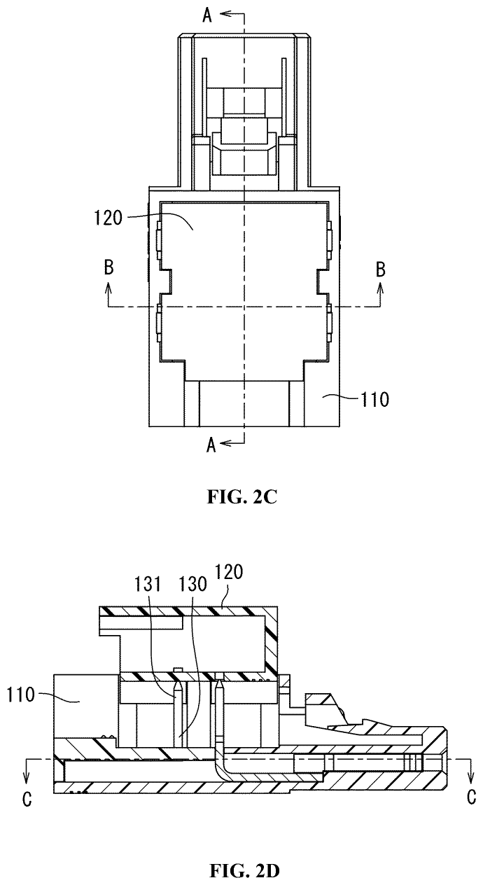

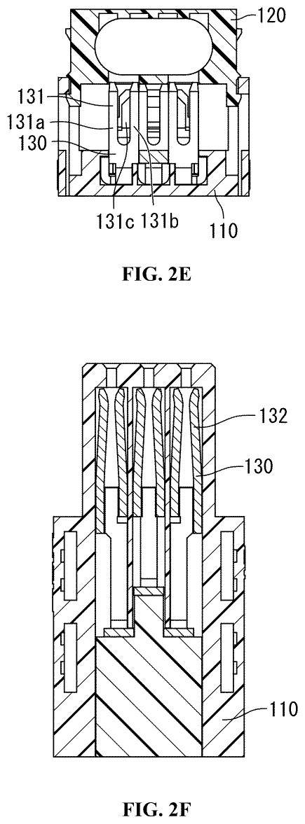

As shown in FIGS. 1 and 2A-2B, the cable side connector 100 includes two cable side connectors 100. One of the two cable side connectors 100, as shown in FIG. 2B, is a first cable side connector 100A for use in a power source or an electric input. As shown in FIG. 2A, the other of the two cable side connectors 100 is a second cable side connector 100B which functions as a power source or an electric output.

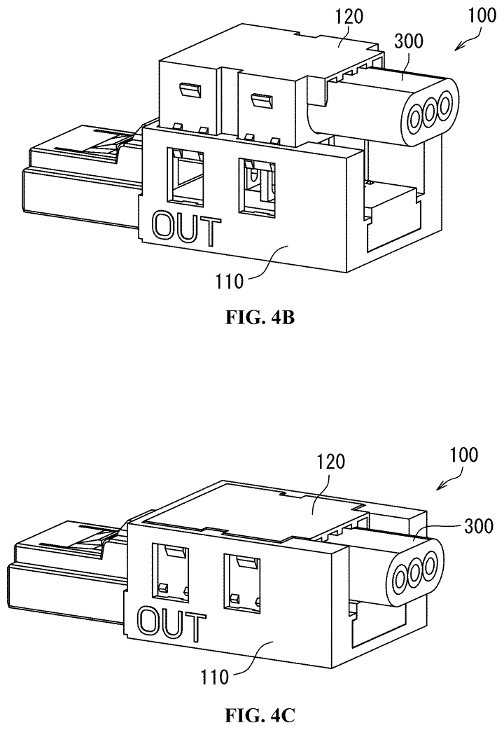

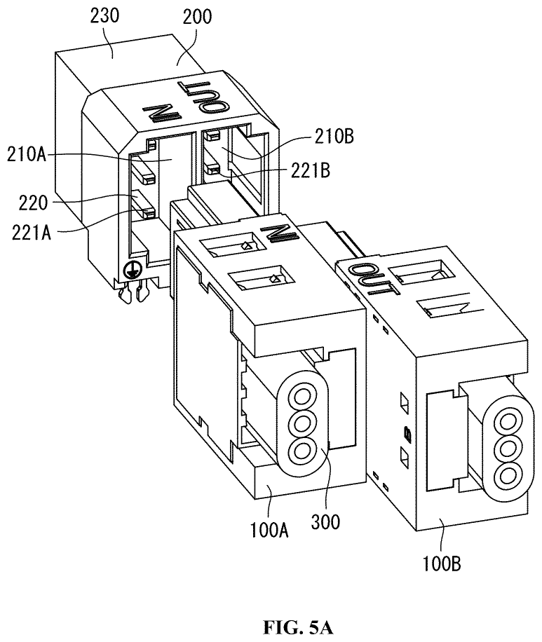

As shown in FIGS. 2A-2B, each of the first cable side connector 100A and the second cable side connector 100B include a main body part 110 in which a plurality of first compound contacts 130 are placed, and a movable part 120 connected to the main body part 110. The movable part 120, as shown in FIGS. 4B-4C, is able to move in one direction into the main body part 110. The number of first compound contacts 130, as shown in FIGS. 2B, and 2D-2F, that are placed corresponds to the number of conductors 310 that are provided in a cable 300 described in more detail below. Each first compound contact 130 can be made from a metallic material such as copper.

As shown in FIGS. 2E-2F, each of the plurality of first compound contacts 130 has an insulation displacement contact 131 at a first end side thereof, has a contact 132 that is a female contact 132 or a male contact 132 at a second end side thereof, and is configured such that the insulation displacement contact 131 and the female contact 132 or male contact 132 are contiguous to each other. The insulation displacement contact 131 can also be referred to as an “IDC contact”.

As shown in FIGS. 2A-2B, the main body part 110 has a first area 111 in which the insulation displacement contact 131 is able to be placed and a second area 112 that is contiguous to the first area 111 and in which the female or male contact 132 is able to be placed. As shown in FIG. 2A, the second area 112 has an outer surface provided with a catch part 113 that is able to catch a board side connector 200 as described in more detail below.

As shown in FIG. 2A, the movable part 120 has a retaining portion 121 in which the cable 300 is able to be inserted and retained, as shown in FIGS. 4B-4C. For example, the movable part 120 is able to be moved in one direction into the main body part 110, from the position shown in FIG. 4B to the position shown in FIG. 4C, by a worker gripping a bottom surface of the main body part 110 and a top surface of the movable part 120 with a tool such as pliers or pincers.

Because of such a configuration, based on part of the movable part 120 engaging with the main body part 110 prior to insertion of the cable 300, a large portion of the movable part 120 is located further outward than the main body part 110. Meanwhile, the movable part 120 can be moved in one direction into the main body part 110 for insulation displacement connection by the insulation displacement contact 131 of the main body part 110 after the insertion of the cable 300.

The cable 300, as shown in FIG. 1, includes a plurality of conductors 310, insulators 320 separately surrounding each of the plurality of conductors 310, and a sheath 330 surrounding the plurality of conductors 310 equipped with the insulators 320.

For example, the conductors 310 can be made from aluminum, copper, or other substances. The insulators 320 and the sheath 330 can be made from insulating resin. Without limiting the present embodiment, the insulators 320 and the sheath 330 can contain, as one example, at least one type of resin material selected from the group consisting of vinyl resin, phenol resin, epoxy resin, silicone resin, and unsaturated polyester resin. In one example, the cable 300 can be a VVF cable whose insulators 320 and sheath 330 can be made from insulating vinyl resin.

The sheath 330 can surround en bloc the plurality of conductors 310 equipped with the insulators 320. As shown in FIG. 1, the plurality of conductors 310 comprise three conductors 310 one of which functions as a grounding conductor and the other two of which function as conductors 310 for use in power source input or power source output to the power source module.

Movement of the movable part 120 in one direction, as shown in FIGS. 4B and 4C, causes the insulation displacement contact 131 to be pushed into the cable 300 so that each conductor 310 of the cable 300 and each insulation displacement contact 131 contact each other.

The insulation displacement contact 131, as shown in FIG. 2E, includes a first contact pin 131a and a second contact pin 131b that face each other so as to form a groove portion 131c. Each contact pin 131a, 131b can be configured to be pushed into the cable 300.

Specifically, each contact pin 131a,131b is configured such that the width of an upper end side of the groove portion 131c (i.e. the clearance between a distal end side of the first contact pin 131a and a distal end side of the second contact pin 131b) is slightly larger than the diameter of the conductor 310 of the cable 300, thereby making it easy to guide the conductor 310 into the groove portion 131c.

However, the width of a main area of the groove portion 131c other than the upper end side (i.e. the clearance between a main portion of the first contact pin 131a other than the distal end side and a main portion of the second contact pin 131b other than the distal end side) is slightly smaller than the diameter of the conductor 310 of the cable 300 such that both contact pins 131a, 131b pinch and surely make contact with the conductor 310.

With such a configuration, each contact pin 131a,131b, as shown in FIG. 2E, is configured to stick into the insulators 320 and the sheath 330 while not sticking into the conductors 310 of the cable 300.

According to such a configuration, the worker does not need to perform the task of stripping off part of the sheath 330 of each cable 300 and part of each insulator 320 and exposing part of each conductor 310 inside. This makes it possible to bring about an improvement in working efficiency in the connection of cables for use in power sources or electric inputs and outputs.

The main body part 110 can be made from glass-containing polyamide or other substances to ensure strength against an external force. Additionally, the movable part 120 can be made from transparent resin such as polycarbonate or acrylic or other to make it easy to confirm whether each contact pin 131a,131b has stuck into the sheath 330.

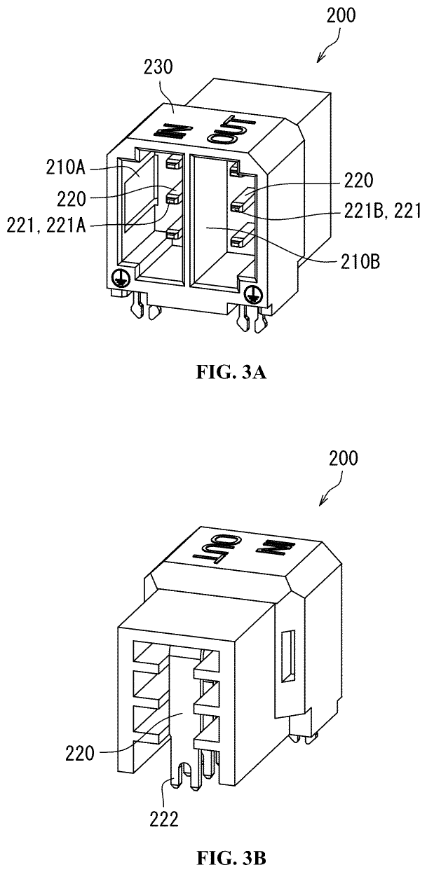

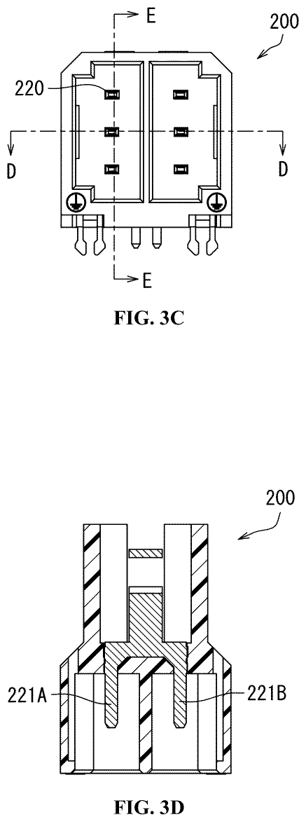

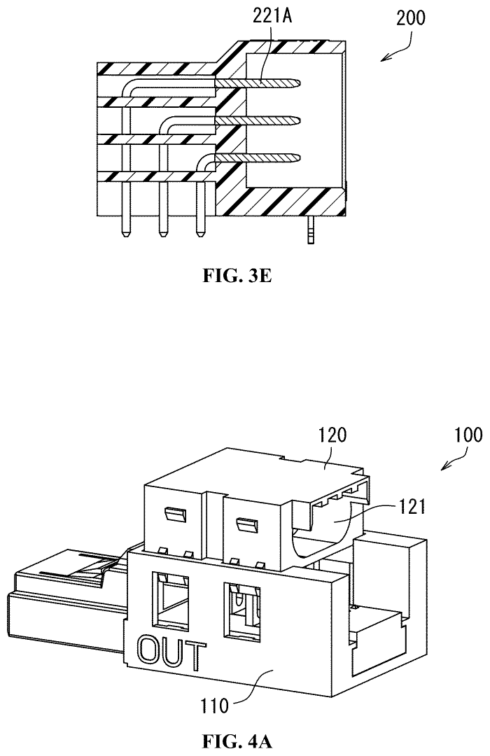

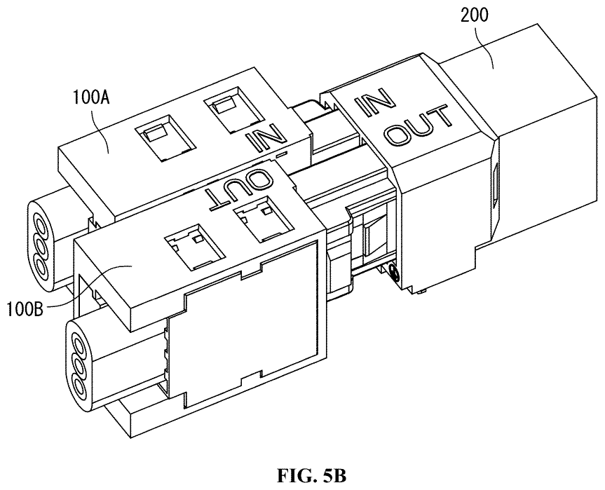

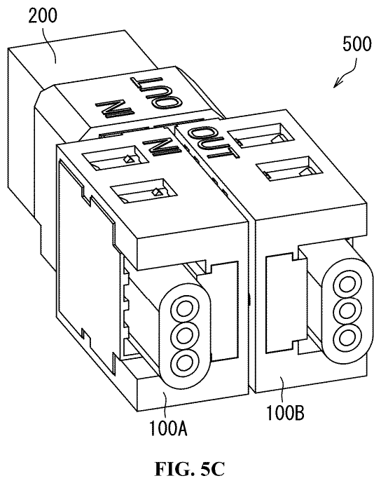

As shown in FIGS. 3A and 5A, the single board side connector 200 has a main body part 230 including a first internal space 210A and a second internal space 210B equipped with openings that are able to receive the first cable side connector 100A and the second cable side connector 100B, respectively. The main body part 230 of the board side connector 200 can be made from glass-containing polyamide or other substances to ensure strength against an external force and to ensure thermal resistance during soldering to a board (e.g. a substrate in the power source module).

As shown in FIGS. 5A and 5B, the first cable side connector 100A is inserted into the first internal space 210A equipped with an opening, and the second cable side connector 100B is inserted into the second internal space 210B equipped with an opening. During insertion, the catch part 113 provided on the outer surface of the main body part 110 of the cable side connectors 100A, 100B catches the board side connector 200, whereby the state of mating of the first and second cable side connectors 100A and 100B with the board side connector 200 can be maintained.

As shown in FIGS. 3A and 5A, an inside of the board side connector 200 has a second compound contact 220 for contact with the board (e.g. the substrate in the power source module) for a power source or electric input and output. The number of second compound contacts 220 corresponds to the number of conductors 310 that are provided in the cable 300. The second compound contact 220 can be made from a metallic material such as copper.

As shown in FIGS. 3A, 3D, and 5A, a first side end of the second compound contact 220 is a contact 221 (221A,221B). The contact 221 can be a male contact 221A or a female contact 221B that is able to be mated with the female or male contact 132 provided in the first cable side connector 100A and/or that is able to be mated with the female or male contact 132 provided in the second cable side connector 100B. As shown in FIGS. 3A, 3D, and 5A, a contact 221A can be placed in the first internal space 210A, and a contact 221B can be placed in the second internal space 210B. However, as shown in FIG. 3B, a second end side of the second compound contact 220 can be a board connecting contact 222 that is able to be electrically connected to the board.

In the present embodiment, the contact 221A placed in the first internal space 210A and the contact 221B placed in the second internal space 210B can be contiguous to each other in the board side connector 200. Without limiting the present embodiment, in an example, the contact 221A placed in the first internal space 210A and the contact 221B placed in the second internal space 210B may be separate from each other inside the board side connector 200 and may be contiguous to each other, for example, via a copper foil wire of the board outside the board side connector 200.

The foregoing configuration makes it possible to electrically connect the cable side connector 100 to the board side connector 200 by mating of the contacts of each connector 100,200. This makes it possible to make a suitable electrical connection premised on power source input (or power supply) and power source output between the cable 300 having a plurality of conductors 310 and the power source module via the connector combined body 500. That is, the connector combined body 500 is interposed between the cable 300 and the power source module so that the cable 300 and the power source module are able to be electrically connected to each other.

Using the connector combined body 500 of the present disclosure makes it possible to constitute an LED lighting unit by electrically connecting the cable 300, the connector combined body 500, the power source module, and an LED to one another this order. Additionally, doing so makes it possible to place a plurality of the LED lighting units at predetermined spacings and electrically connecting adjacent LED lighting units to each other.

A method for using the cable side connector 100 of the connector combined body 500 is now described with reference to FIGS. 4A-4C.

First, as shown in FIG. 4A, in a prior-to-use state of the cable side connector 100, cable side connectors 100 are prepared for use as the first cable side connector 100A and the second cable side connector 100B. Although FIGS. 4A-4C show an example in which the second cable side connector 100B is used, similar procedures are done for the first cable side connector 100A.

Next, as shown in FIG. 4B, in a first usage state of the cable side connector 100, the cable 300 is inserted into the cable retaining portion 121 of the movable part 120 of the first cable side connector 100A and the second cable side connector 100B. Next, in a second usage state of the cable side connector 100, the movable part 120 is moved, from the position shown in FIG. 4B to the position shown in FIG. 4C, in one direction into the main body part 120 with a tool such as pliers or pincers. Such movement of the movable part 120 in one direction causes the insulation displacement contact 131 to be pushed into the cable 300 so that each conductor 310 of the cable 300 and each insulation displacement contact 131 make contact with each other.

According to such a configuration, the worker does not need to perform the task of stripping off part of the sheath 330 of each cable 300 and part of each insulator 320 to expose part of each conductor 310 inside. This makes it possible to bring about an improvement in working efficiency in the connection of cables for use in power sources or electric inputs and outputs. Thus, contact is made between each insulation displacement contact 131 of each first cable side connector 100A and second cable side connector 100B and each conductor 310 of the cable 300.

A method for using the connector combined body 500 after the first cable side connector 100A and the second cable side connector 100B are in the second usage state of the cable side connector 100 shown in FIG. 4C, is now described with reference to FIGS. 5A-5C.

First, as shown in FIG. 5A, in a first usage state of the connector combined body 500, the preparation is done for inserting the first cable side connector 100A into the first internal space 210A of the board side connector 200. Further, as further shown in FIG. 5A, preparation is also done for inserting the second cable side connector 100B into the second internal space 210B of the board side connector 200.

Next, as shown in FIG. 5B, in a second usage state of the connector combined body 500, the insertion of the first cable side connector 100A into the first internal space 210A of the board side connector 200 is started. Further, as further shown in FIG. 5B, the insertion of the second cable side connector 100B into the second internal space 210B of the board side connector 200 is started.

After that, the insertion is continued so that the insertion of the first cable side connector 100A into the first internal space 210A of the board side connector 200 is completed, as shown in a third usage state of the connector combined body 500 shown in FIG. 5C. Further, the insertion of the second cable side connector 100B into the second internal space 210B of the board side connector 200 is completed, as further shown in FIG. 5C.

A connector combined body assembly is the connection, as shown in FIG. 5C, of the first cable side connector 100A, connected to the cable 300, into the first internal space 210A of the board side connector 200 and the second cable side connector 100B, connected to the cable 300, into the second internal space 210B of the board side connector 200.

The foregoing makes it possible to electrically connect the cable side connector 100 to the board side connector 200 by mating the contacts of each connector 100,200 to each other. This makes it possible to make a suitable electrical connection premised on power source input (or power supply) and power source output between the cable 300 having a plurality of conductors 310 and the power source module via the connector combined body 500 of the present disclosure.

Although embodiments of the present disclosure have been described above, the present disclosure is not limited to these embodiments. Various changes based on the knowledge of persons skilled in the art, such as a combination of the forgoing configurations, can be made without departing from the scope of the claims.

1. A connector combined body, comprising:
a cable side connector including a main body part, a movable part connected to the main body part, and a first compound contact disposed in the main body part, the movable part is movable in one direction into the main body part and has a retaining portion in which a cable is inserted and retained, the cable includes a plurality of conductors, a plurality of insulators each separately surrounding one of the conductors, and a sheath surrounding the insulators, a first end side of the first compound contact is an insulation displacement contact, a movement of the movable part in the one direction pushes the insulation displacement contact into contact with the conductors of the cable; and
a board side connector electrically connected and mated with the cable side connector.

2. The connector combined body of claim 1, wherein the cable side connector is one of a pair of cable side connectors, one of the pair of cable side connectors is a first cable side connector and the other of the pair of cable side connectors is a second cable side connector, the first cable side connector and the second cable side connector each mate with one board side connector.

3. The connector combined body of claim 1, wherein the board side connector has a second compound contact disposed in the board side connector, a second end side of the first compound contact mates with the second compound contact.

4. The connector combined body of claim 3, wherein the second end side of the first compound contact is a female contact, and the second compound contact has a male contact.

5. The connector combined body of claim 3, wherein the main body part has a first area in which the insulation displacement contact is disposed and a second area that is contiguous to the first area receiving the second compound contact.

6. The connector combined body of claim 5, wherein the second area has an outer surface with a catch part that catches the board side connector.

7. The connector combined body of claim 1, wherein the connector combined body is interposed between the cable and a power source module, the connector combined body electrically connects the cable and the power source module to each other.

8. The connector combined body of claim 2, wherein the board side connector has a board main body with a first internal space and a second internal space separate from the first internal space, each of the first internal space and the second internal space receives one of the pair of cable side connectors.

9. The connector combined body of claim 3, wherein the second end side of the first compound contact is a male contact, and the second compound contact has a female contact.

10. The connector combined body of claim 1, wherein the main body part is made of a glass-containing polyamide.

11. The connector combined body of claim 1, wherein the movable part is made of a transparent resin.

12. A connector combined body assembly, comprising:
a cable including a plurality of conductors, a plurality of insulators each separately surrounding one of the conductors, and a sheath surrounding the insulators; and
a connector combined body including a cable side connector having a main body part, a movable part connected to the main body part, and a first compound contact disposed in the main body part, the movable part is movable in one direction into the main body part and has a retaining portion in which the cable is inserted and retained, the connector combined body includes a board side connector electrically connected and mated with the cable side connector, a first end side of the first compound contact is an insulation displacement contact, a movement of the movable part in the one direction pushes the insulation displacement contact into contact with the conductors of the cable.

13. The connector combined body assembly of claim 12, wherein the insulation displacement contact has a first contact pin and a second contact pin that face each other to form a groove portion between the first contact pin and the second contact pin.

14. The connector combined body assembly of claim 13, wherein a width of an upper end side of the groove portion is larger than a diameter of one of the conductors of the cable.

15. The connector combined body assembly of claim 14, wherein a width of a main area of the groove portion, other than the width of the upper end side, is smaller than the diameter of the one of the conductors of the cable.
